(19) United States
(12) Patent Application Publication
(10) Pub. No.: US 2007/0172406 A1
(43) Pub. Date: Jul. 26, 2007

(54) Nanoscale, crystalline silicon powder

(75) Inventors: Markus Pridoehl, Grosskrotzenburg (DE); Paul Roth, Kempen (DE); Hartmut Wiggers, Reken (DE); Peter Kress, Karlstein (DE); Guido Zimmermann, Hanau (DE); Stefan Heberer, Gelnhausen (DE); Frank-Martin Petrat, Muenster (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Dusseldorf (DE)

(21) Appl. No.: 10/579,762

(22) PCT Filed: Nov. 13, 2004
(86) PCT No.: PCT/EP04/12889

§ 371 Date: Jan. 30, 2007

(30) Foreign Application Priority Data
Nov. 19, 2003 (DE) 103 53 996.4

(51) Int. Cl. C01B 33/00

(52) U.S. Cl. 423/324

(57) ABSTRACT

Aggregated, crystalline silicon powder with a BET surface of more than 50 m²/g. The powder is produced by continuously feeding at least one vaporous or gaseous silane and optionally at least one vaporous or gaseous doping substance and an inert gas into a reactor and mixing the components there, wherein the proportion of silane is between 0.1 and 90 wt. % referred to the sum total of silane, doping substance and inert gas, the mixture is caused to react by input of energy, wherein a plasma is produced by the input of energy by means of electromagnetic radiation in the microwave range at a pressure of 10 to 1100 mbar, the reaction mixture is allowed to cool and the reaction product is separated in the form of a powder from gaseous substances. The powder may be used for the production of electronic components.

The present invention relates to a nanoscale, crystalline silicon powder, its production and use.

Nanoscale silicon powders are of great interest on account of their special optical and electronic properties.

It is known to produce silicon by pyrolysis of silane (SiH₄). In U.S. Pat. No. 4,661,335 an aggregated, largely polycrystalline silicon powder with a low density and a BET surface of between 1 and 2 m²/g is described, which is obtained by pyrolysis of silane at temperatures between 500° C. and 700° C. in a tubular reactor. Such a powder no longer meets present day requirements. The process is furthermore not economical due to the large content of unreacted silane.

In Laser Physics, Vol. 10, pp. 939-945 (2000) Kuz'min et al. describe the production of a nanoscale silicon product by means of laser-induced decomposition of silane at reduced pressure. Each individual particle of the powder thereby produced has a polycrystalline core of 3 to 20 nm and an amorphous covering with a diameter of up to 150 nm. No information is given regarding the surface of the silicon powder.

In J. Mater. Sci. Technol., Vol. 11, pp. 71-74 (1995) Li et al. describe the synthesis of aggregated, polycrystalline silicon powder by laser-induced decomposition of silane in the presence of argon as diluent gas at atmospheric pressure. No information is given regarding the surface of the silicon powder.

In Vacuum, Vol. 45, pp. 1115-1117 (1994) Costa et al. describe an amorphous silicon powder whose surface contains a large proportion of hydrogen. The silicon powder is produced by decomposition of silane by means of a radio-frequency plasma reactor in vacuo.

In Jap. J. Appl. Physics, Vol 41, pp. 144-146 (2002) Makimura et al. describe the production of hydrogen-containing silicon nanoparticles by laser attrition of a silicon target in vacuo in the presence of hydrogen and neon. No information is given as to whether the silicon nanoparticles exist in crystalline or amorphous form.

EP-A-680384 describes a process for the deposition of a non-polycrystalline silicon on a substrate by decomposition of a silane in a microwave plasma at reduced pressure. No information is given regarding the surface properties of the silicon.

It is known to produce aggregated, nanoscale silicon powder in a hot-wall reactor (Roth et al., Chem. Eng. Technol. 24 (2001), 3). A disadvantage of this process is that the desired crystalline silicon occurs together with amorphous silicon, which is formed by reaction of the silane on the hot reactor walls. The crystalline silicon in addition has a low BET surface of less than 20 m²/g and is thus as a rule too coarse for electronic applications. Furthermore no process is described by Roth et al. in which doped silicon powders are obtained. Such doped silicon powders are, on account of their semiconductor properties, of great importance in the electronics industry. A disadvantage however is that silicon powder is deposited on the reactor walls and acts as an insulator. The temperature profile in the reactor consequently changes, and thus also the properties of the silicon powder that is produced.

The prior art demonstrates the intense interest in silicon powders. The object of the present invention is to provide a silicon powder that avoids the disadvantages of the prior art. In particular, the silicon powder should be one having a uniform modification. The powder should be capable of meeting the growing demands for miniaturisation in the production of electronic components.

The object of the invention is also a process for the production of this powder.

The present invention provides an aggregated, crystalline silicon powder that is characterised in that it has a BET surface of more than 50 m²/g.

In a preferred embodiment the silicon powder according to the invention may have a BET surface of 100 to 700 m²/g, the range from 200 to 500 m²/g being particularly preferred.

The term aggregated is understood to mean that spherical or largely spherical primary particles, such as for example as are first of all formed in the reaction, coalesce to form aggregates during the further course of the reaction. The degree of coalescence of the aggregates can be influenced by the process parameters. These aggregates may form agglomerates during the further course of the reaction. In contrast to the aggregates, which as a rule cannot be decomposed, or only partially so, into the primary particles, the agglomerates form an only loose concretion of aggregates.

The term crystalline is understood to mean that at least 90% of the powder is crystalline. Such a degree of crystallinity can be determined by comparing the intensitites of the [111 ],[220] and [311] signals of the powder according to the invention with a silicon powder of known crystallinity and crystal size.

Within the context of the invention a silicon powder with a crystalline fraction of at least 95%, particularly preferably with a crystalline fraction of at least 98%, is preferred. The evaluation of TEM images and counting of the primary particles that exhibit lattice grid lines as a feature of the crystalline state are suitable for determining the degree of crystallinity.

The silicon powder according to the invention may have a hydrogen loading of up to 10 mole %, a range from 1 to 5 mole % being preferred. NMR spectroscopy methods, such as for example ¹H-MAS-NMR spectroscopy, or IR spectroscopy are suitable for determining the degree of saturation.

Furthermore the silicon powder according to the invention may be doped. The following elements may preferably be employed as doping components, especially for use as semiconductors in electronics components: phosphorus, arsenic, antimony, bismuth, boron, aluminium, gallium, indium, thallium, europium, erbium, cerium, praseodymium, neodymium, samarium, gadolinium, terbium, dysprosium, holmium, thulium, ytterbium or lutetium. The proportion of these elements in the silicon powder according to the invention may be up to 1 wt. %. As a rule a silicon powder may be desirable in which the doping component is contained in the ppm or even ppb range. A range from 10¹³ to 10¹⁵ atoms of doping component/cm³ is preferred.

In addition it is possible for the silicon powder according to the invention to contain lithium as doping component. The proportion of lithium in the silicon powder may be up to 53 wt. %. Silicon powders with up to 20 to 40 wt. % of lithium may be particularly preferred.

Likewise, the silicon powder according to the invention may contain germanium as doping component. In this case the proportion of germanium is up to 40 wt. %. Silicon powders containing 10 to 30 wt. % of germanium may be particularly preferred.

Finally, the elements iron, ruthenium, osmium, cobalt, rhodium, iridium, nickel, palladium, platinum, copper, silver, gold and zinc may also be used as doping component of the silicon powder. Their proportion may be up to 5 wt. % of the silicon powder.

The doping component may in this connection be distributed homogeneously in the powder, or may be concentrated or intercalated in the covering or in the core of the primary particles. The doping components may preferably be incorporated at lattice sites of the silicon. This depends substantially on the nature of the doping substance and the reaction conditions.

The term doping component is understood within the context of the invention to denote the element present in the powder according to the invention. The term doping substance is understood to denote the compound that is used in the process in order to obtain the doping component.

The present invention also provides a process for the production of the silicon powder according to the invention, which is characterised in that
at least one vaporous or gaseous silane and optionally at least one vaporous or gaseous doping substance,
together with an inert gas
are continuously transferred to a reactor and mixed therein,
   wherein the proportion of the silane is between 0.1 and 90 wt. % referred to the sum total of silane, doping substance and inert gases,
and a plasma is produced by input of energy by means of electromagnetic radiation in the microwave range at a pressure of 10 to 1100 mbar,
the reaction mixture is allowed to cool or is cooled and the reaction product is separated in the form of a powder from gaseous substances.

The process according to the invention is characterised in that a stable plasma is produced that leads to a very uniform product and, in contrast to processes that operate in a high vacuum, allows high conversion rates. As a rule the conversion of silane is at least 98%.

The process according to the invention is carried out so that the proportion of silane, optionally with the inclusion of the doping component, in the gas stream is between 0.1 and 90 wt. %. A high silane content leads to a high throughput and is therefore economically sensible. With very high silane contents however a formation of larger aggregates is to be expected. A silane content of between 1 and 10 wt. % is preferred in the context of the invention. At this concentration aggregates with a diameter of less than 1 μm are as a rule obtained.

Within the context of the invention a silane may be a silicon-containing compound that yields silicon, hydrogen, nitrogen and/or halogens under the reaction conditions. SiH₄, Si₂H₆, Cl₂SiH₃, Cl₂SiH₂, Cl₃SiH and/or SiCl₄ may preferably be used, SiH₄ being particularly preferred. In addition it is also possible to use N(SiH₃)₃, HN(SiH₃)₂, H₂N(SiH₃), (H₃Si)₂NN(SiH₃)₂, (H₃Si)NHNH(SiH₃) or H₂NN(SiH₃)₂.

A doping substance within the meaning of the invention may be a compound that contains the doping component covalently or ionically bonded and that yields the doping component, hydrogen, nitrogen, carbon monoxide, carbon dioxide and/or halogens under the reaction conditions. There may preferably be used hydrogen-containing compounds of phosphorus, arsenic, antimony, bismuth, boron, aluminium, gallium, indium, thallium, europium, erbium, cerium, praseodymium, neodymium, samarium, gadolinium, terbium, dysprosium, holmium, thulium, ytterbium, lutetium, lithium, germanium, iron, ruthenium, osmium, cobalt, rhodium, iridium, nickel, palladium, platinum, copper, silver, gold or zinc. Particularly preferred are diborane and phosphane or substituted phosphanes such as tBuPH₂, tBu₃P, tBuPh₂P or tBuPh₂P and trismethylaminophosphane ((CH₃)₂N)₃P. In the case where lithium is used as doping component, it has proved most convenient to employ the metal lithium or lithium amide (LiNH₂) as doping substance.

As inert gas there may mainly be used nitrogen, helium, neon or argon, argon being particularly preferred.

The energy input is not limited. Preferably the energy input should be chosen so that the back-scattered, unabsorbed microwave radiation is minimal and a stable plasma is formed. As a rule, in the process according to the invention the power input is between 100 W and 100 KW, and particularly preferably between 500 W and 6 KW. In this connection the particle size distribution may be varied by the radiated microwave energy. Thus, for identical gas compositions and volume flows, higher microwave energies may lead to a smaller particle size and to a narrower particle size distribution.

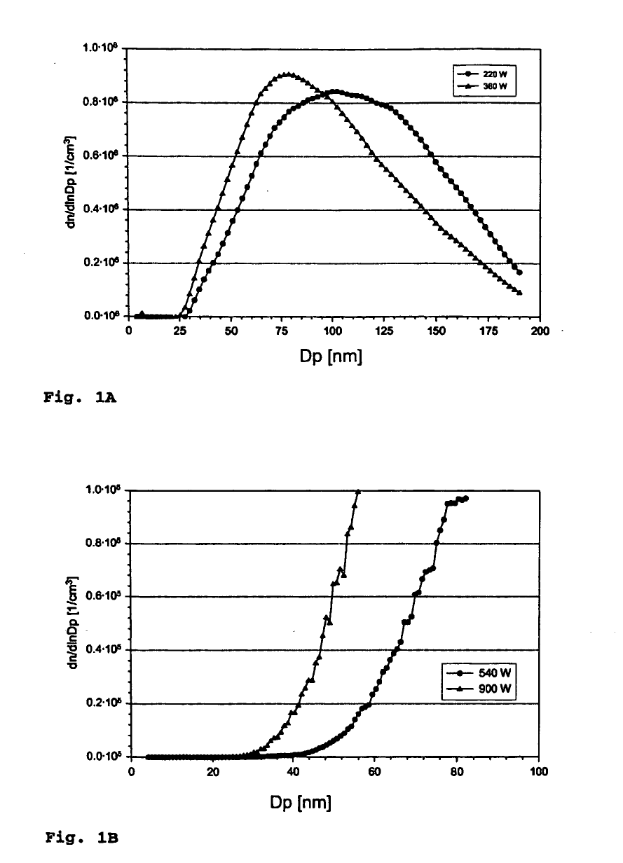

FIG. 1A shows the particle size distribution determined using a differential mobility analyser (DMA), at 220 and 360 W emitted microwave output, a total volume flow of 4000 sccm and an SiH₄ concentration of 0.375%. In addition to a smaller mean particle size and a sharper particle size distribution, the start of the particle distribution is also shifted to smaller values.

FIG. 1B shows a detail of incipient particle growth for a synthesis at 8000 sccm total volume flow, a radiated microwave energy of 540 and 900 W and an SiH₄ concentration of 0.375%.

FIGS. 1A and 1B show qualitatively the same result. By comparing the two it is clear that at higher volume flows more energy must be made available in order to produce particles of comparable size. The plotted numerical values are not comparable with one another since different dilution stages had to be employed to adapt the measurement process.

The pressure range in the process according to the invention is between 10 mbar and 1100 mbar. This means that a higher pressure as a rule leads to a silicon powder according to the invention with a lower BET surface, while a lower pressure leads to a silicon powder according to the invention with a larger surface. Thus, in a range of up to 100 mbar, large surface area silicon powders with a BET surface of up to 700 m²/g can be obtained, whereas in a range from ca. 900 up to 1100 mbar, silicon powders with a BET surface of 50 up to 150 g/m² can be obtained.

Microwave range is understood in the context of the invention to denote a range from 900 MHz to 2.5 GHz, a frequency of 915 MHz being particularly preferred.

The cooling of the reaction mixture may for example take place by an external wall cooling of the reactor or by introducing inert gas.

Preferably the process according to the invention may be carried out in such a way that hydrogen, optionally in a mixture with an inert gas, is additionally introduced into the reactor. The proportion of hydrogen may lie in a range from 1 to 96 vol.%

It may furthermore be advantageous to carry out the process according to the invention so that the reaction mixture that is produced by the input of energy by means of electromagnetic radiation in the microwave range at a pressure of 10 to 1100 mbar is thermally post-treated. Reaction mixture is in this context understood to denote the mixture consisting of the silicon powder according to the invention and further reaction products as well as unreacted starting products.

The aggregate structure, the BET surface and possibly the hydrogen content of the silicon powder may be varied by the thermal post-treatment. Likewise the thermal post-treatment may lead to an increase in the crystallinity of the silicon powder or the density of defects in the crystal lattice may be reduced.

The thermal post-treatment may be carried out in the presence of at least one doping substance, the doping substance being introduced together with an inert gas and/or hydrogen.

Particularly preferably a wall-heated hot-wall reactor may be used for the thermal post-treatment of the reaction mixture, the hot-wall reactor being dimensioned so that a chosen doping substance is decomposed and may be incorporated as doping component in the silicon powder. Depending on this, the residence time in the hot-wall reactor is between 0.1 sec and 2 sec, preferably between 0.2 sec and 1 sec. This type of doping is preferably used with only low degrees of doping. The maximum temperature in the hot-wall reactor is preferably chosen so that it does not exceed 1000° C.

In addition to the thermal post-treatment of the reaction mixture it is also possible to obtain a silicon powder according to the invention by thermal post-treatment of the reaction product that is present after the energy input by means of electromagnetic radiation in the microwave range at a pressure of 10 to 1100 mbar followed by cooling and separation of gaseous substances. In this connection it is also possible to carry out the thermal post-treatment in the presence of at least one doping substance.

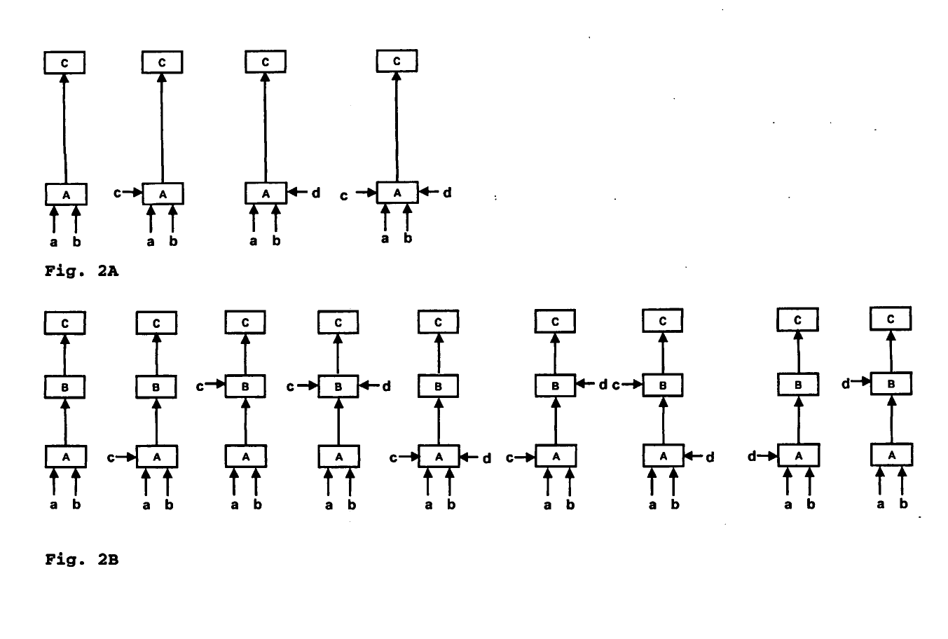

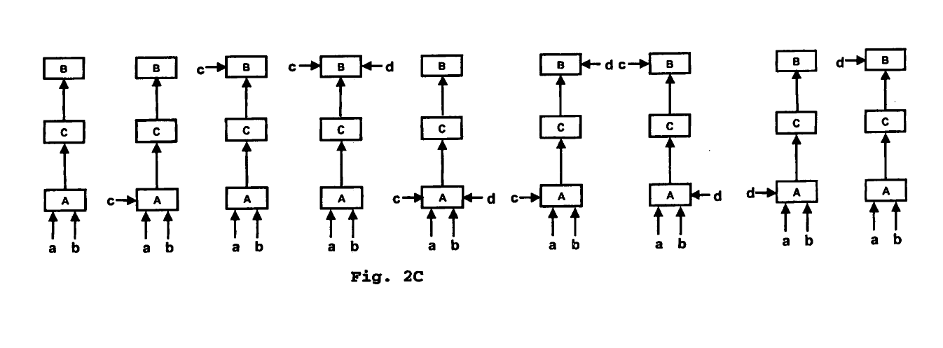

FIGS. 2A-C illustrate the possible embodiments of the process according to the invention, in which a=silane, b=inert gas, c=doping substance, d=hydrogen. Furthermore A=microwave reactor, B=thermal post-treatment, C=separation of the silicon powder from gaseous reaction products. The doping substance c is as a rule introduced with an inert gas. FIG. 2A shows an arrangement in which only a microwave reactor is employed, while FIGS. 2B and 2C include a thermal post-treatment.

A section of FIG. 2A shows the production of the silicon powder from the two essential constituents for the process according to the invention, namely silane and inert gas. In addition FIG. 2B illustrates the thermal post-treatment of the reaction mixture from the microwave reactor with subsequent separation of the silicon powder.

FIG. 2C illustrates the thermal post-treatment of the silicon powder that was separated in a preceding step from gaseous reaction products and starting substances. The process according to the invention may preferably be carried out as illustrated in FIG. 2A.

The present invention also provides for the use of the powder according to the invention for producing electronic components, electronic circuits and electrically active fillers.

### EXAMPLES

Analysis: The BET surface is determined according to DIN 66131. The degree of doping is determined by means of glow discharge mass spectrometry (GDMS). The hydrogen loading is determined by means of ¹H-MAS-NMR spectroscopy.

Apparatus: A microwave generator (Muegge company)is used to produce the plasma. The microwave radiation is focussed in the reaction space by means of a tuner (3-rod tuner). A stable plasma is generated in the pressure range from 10 mbar up to 1100 mbar and at a microwave output of 100 to 6000 W by the design of the wave guide, the fine adjustment by means of the tuner and the accurate positioning of the nozzle acting as electrode.

The microwave reactor consists of a quartz glass tube of 30 mm diameter (external) and a length of 120 mm, which is employed in the plasma applicator.

A hot-wall reactor may be connected downstream of the microwave reactor. For this, a longer quartz glass tube with a length of 600 mm is used. The mixture leaving the microwave reactor is heated by an externally heated zone (length ca. 300 mm).

### Example 1

An SiH₄/argon mixture (mixture 1) of 100 sccm (standard centimetre cube per minute; 1 sccm=1 cm³ gas per minute referred to 0°C. and atmospheric pressure) of SiH₄ and 900 sccm of argon as well as a mixture of 10000 sccm of each of argon and hydrogen (mixture 2), are fed through a two-fluid nozzle to the microwave reactor. An output of 500 W from a microwave generator is fed to the gaseous mixture and a plasma is thereby produced. The plasma flare leaving the reactor through a nozzle expands into a space whose volume of ca. 20l is large compared to the reactor. The pressure in this space and in the reactor is adjusted to 200 mbar. The pulverulent product is separated from gaseous substances in a downstream-connected filter unit.

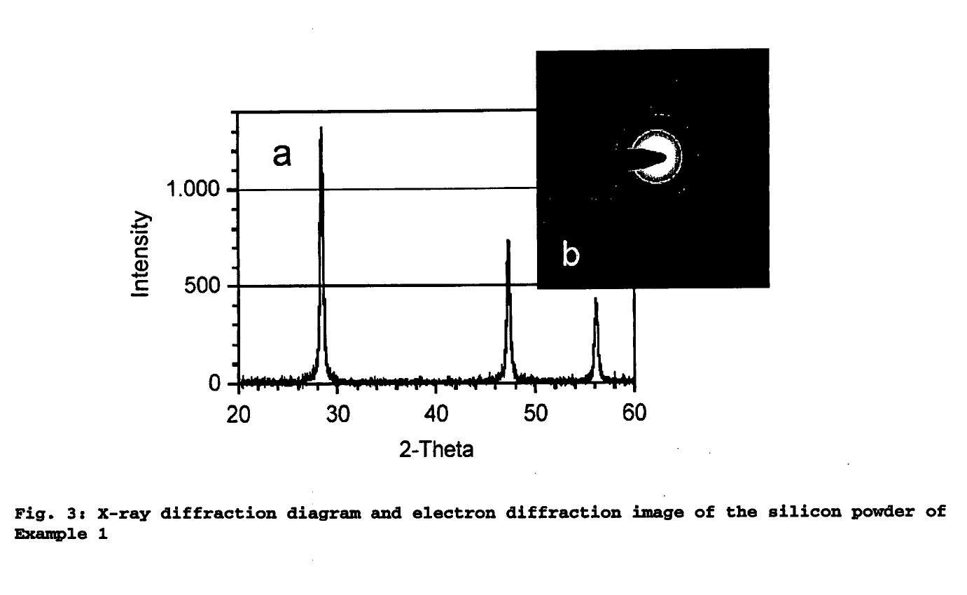

The powder obtained has a BET surface of 130m²/g. FIG. 3 shows the X-ray diffraction diagram of the silicon powder.

Examples 2 to 7 are carried out analogously to Example 1, though with altered parameters. These are given in Table 1.

Example 5 describes the production of a boron-doped silicon powder. For this, a diborane/argon mixture (0.615% B₂H₆ in argon) is additionally mixed in with the mixture 1. The degree of doping determined by means of GDMS corresponds to the added amount of diborane.

Example 6 describes the production of a phosphorus-doped silicon powder. For this, a tri-tert.-butylphosphane/ argon mixture (0.02% (tBu)₃P) in argon) is in addition mixed in with the mixture 1. The degree of doping determined by means of GDMS corresponds to the added amount of tri-tert.-butylphosphane.

Example 7 shows the production of a silicon powder by means of a combination of microwave reactor and hot-wall reactor. In contrast to Example 4, which was carried out using only a microwave reactor, the BET surface of the silicon powder is reduced slightly. In addition the intensity of the IR signals at 2400 cm⁻¹ and 2250 cm⁻¹ are significantly reduced compared to Example 4, whereas the intensity of the signal at 2100 cm⁻¹ is increased.

The advantages of the silicon powder according to the invention are the following: it is nanoscale, crystalline and has a large surface, and can be doped. According to XRD and TEM images it is free of amorphous constituents and the BET surface may assume values of up to 700 m²/g.

TABLE 1
Process parameters and physicochemical values of the silicon powders

| | | Example | | | | | | |
|---|---|---|---|---|---|---|---|---|
| | | 1 | 2 | 3 | 4 | 5 | 6 | 7 |
| Mixture 1 | | | | | | | | |
| SiH₄ | sccm | 100 | 8 | 50 | 10 | 100 | 100 | 10 |
| Argon | sccm | 900 | 72 | 1950 | 90 | 1890 | 1600 | 90 |
| B₂H₆ | sccm | — | — | — | — | 10 | — | — |
| (tBu)₃P | sccm | — | — | — | — | — | 300 | — |
| Mixture 2 | | | | | | | | |
| Hydrogen | sccm | 10000 | 100 | 2000 | 7500 | 10000 | 10000 | 7500 |
| Argon | sccm | 10000 | 8000 | 8000 | 200 | 10000 | 10000 | 200 |
| Microwave output | W | 500 | 300 | 1500 | 540 | 1000 | 1000 | 540 |
| Pressure | mbar | 200 | 30 | 20 | 1040 | 200 | 200 | 1040 |
| Temperature of hot- | ° C. | — | — | — | — | — | — | 900 |
| wall reactor | | | | | | | | |
| BET Si powder | m²/g | 130 | 567 | 650 | 63 | 132 | 129 | 56 |
| H loading | mole % | 1.5 | n.d. | 2.7 | n.d. | n.d. | n.d. | n.d. |
| Degree of doping | ppm | — | — | — | — | 1200 | 620 | — |

n.d. = not determined

1. Aggregated, crystalline silicon powder, characterised in that it has a BET surface of more than 50 m²/g.

2. Aggregated, crystalline silicon powder according to claim 1, characterised in that the BET surface lies between 100 and 700 m²/g.

3. Aggregated, crystalline silicon powder according to claim 1, characterised in that it has a hydrogen loading of up to 10 mole %.

4. Aggregated, crystalline silicon powder according to claim 1, characterised in that it is doped with phosphorus, arsenic, antimony, bismuth, boron, aluminium, gallium, indium, thallium, europium, erbium, cerium, praseodymium, neodymium, samarium, gadolinium, terbium, dysprosium, holmium, thulium, lutetium, lithium, germanium, iron, ruthenium, osmium, cobalt, rhodium, iridium, nickel, palladium, platinum, copper, silver, gold or zinc.

5. Aggregated, crystalline silicon powder according to claim 4, characterised in that the proportion of the doping components phosphorus, arsenic, antimony, bismuth, boron, aluminium, gallium, indium, thallium, europium, erbium, cerium, praseodymium, neodymium, samarium, gadolinium, terbium, dysprosium, holmium, thulium, ytterbium and lutetium is up to 1 wt. %.

6. Aggregated, crystalline silicon powder according to claim 4, characterised in that the proportion of the doping component lithium is up to 53 wt. %.

7. Aggregated, crystalline silicon powder according to claim 4, characterised in that the proportion of the doping component germanium is up to 40 wt. %.

8. Aggregated, crystalline silicon powder according to claim 4, characterised in that the proportion of the doping components iron, ruthenium, osmium, cobalt, rhodium, iridium, nickel, palladium, platinum, copper, silver, gold and zinc is up to 5 wt. %.

9. Process for the production of the silicon powder according to claim 1, characterised in that
at least one vaporous or gaseous silane and optionally at least one vaporous or gaseous doping substance,
and an inert gas
are continuously transferred to a reactor and mixed therein,
wherein the proportion of the silane is between 0.1 and 90 wt. % referred to the sum total of silane, doping substance and inert gases,
and a plasma is produced by input of energy by means of electromagnetic radiation in the microwave range at a pressure of 10 to 1100 mbar,
the reaction mixture is allowed to cool and the reaction product is separated in the form of a powder from gaseous substances.

10. Process according to claim 9, characterised in that the proportion of silane, optionally with the inclusion of the doping component, in the gas stream is between 1 and 10 wt %.

11. Process according to claim 9 characterised in that the silane is selected from the group of compounds SiH₄, Si₂H₆,ClSiH₃, Cl₂SiH₂, Cl₃SiH and/or SiCl₄.

12. Process according to claim 9, characterised in that the silane is selected from the group of compounds N(SiH₃)₃, HN(SiH₃)₂, H₂N(SiH₃), (H₃Si)₂NN(SiH₃)₂, (H₃Si)NHNH(SiH₃), H₂NN(SiH₃)₂.

13. Process according to claim 9, characterised in that the doping substance is selected from the group of hydrogen-containing compounds of phosphorus, arsenic, antimony, bismuth, boron, aluminium, gallium, indium, thallium, europium, erbium, cerium, praseodymium, neodymium, samarium, gadolinium, terbium, dysprosium, holmium, thulium, ytterbium, lutetium, lithium, germanium, iron, ruthenium, osmium, cobalt, rhodium, iridium, nickel, palladium, platinum, copper, silver, gold or zinc.

14. Process according to claim 9, characterised in that the doping substance is lithium metal or lithium amide (LiNH₂).

15. Process according to claim 9, characterised in that nitrogen, helium, neon or argon are used as inert gases.

16. Process according to claims claim 9, characterised in that hydrogen is additionally introduced into the reactor.

17. Process according to claim 16, characterised in that the proportion of hydrogen lies in a range from 1 to 96 vol. %.

18. Process according to claim 9, characterised in that the reaction mixture is thermally post-treated.

19. Process according to claim 18, characterised in that the thermal post-treatment is carried out in the presence of at least one doping substance, in which the doping substance is introduced together with an inert gas and/or hydrogen.

20. Process according to claim 19, characterised in that the thermal post-treatment of the reaction mixture is carried out by means of a wall-heated hot-wall reactor.

21. Process according to claim 20, characterised in that the reaction product after cooling is again thermally post-treated.

22. Process according to claim 21, characterised in that the thermal post-treatment is carried out in the presence of at least one doping substance.

23. The method of using the silicon powder according to claim 1 for the production of electronic components, electronic circuits and electrically active fillers.
